(19) United States
(12) Patent Application Publication
(10) Pub. No.: US 2007/0123690 A1
(43) Pub. Date: May 31, 2007

(54) Conjugated polymers, representation thereof, and use of the same

(75) Inventors: Amir Parham, Frankfurt (DE); Susanne Heun, Bad Soden (DE); Aurelie Falcou, Frankfurt (DE); Heinrich Becker, Eppstein-Niederjosbach (DE)

Correspondence Address: CONNOLLY BOVE LODGE & HUTZ, LLP, P O BOX 2207, WILMINGTON, DE, 19899, US

(73) Assignee: Merck Patent GmbH, Darmstadt (DE)

(21) Appl. No.: 10/580,293

(22) PCT Filed: Nov. 24, 2004
(86) PCT No.: PCT/EP04/13313

§ 371 Date: May 23, 2006

(30) Foreign Application Priority Data
Nov. 26, 2003 (DE) 103 55 786.5

(51) Int. Cl. C08G 75/00

(52) U.S. Cl. 528/373

(57) ABSTRACT

The present invention relates to conjugated polymers which comprise coumarin structural units or related units of the formula (1). The materials according to the invention exhibit significantly higher photostability than materials in accordance with the prior art and are therefore more suitable for use in polymeric organic light-emitting diodes.

Broad-based research into the commercialisation of display and illumination elements based on polymeric (organic) light-emitting diodes (PLEDs) has been carried out for about 12 years. This development was triggered by basic developments which are disclosed in WO 90/13148. A first, albeit simple, product (a small display in a shaver from PHILIPS N.V.) has also recently been available on the market. However, significant improvements in the materials used are still necessary in order to make these displays a true competitor to the liquid-crystal displays (LCDs) which currently dominate the market.

For the generation of all three emission colours, it is necessary here to copolymerise certain comonomers into the corresponding polymers (cf., for example, WO 00/46321, WO 03/020790 and WO 02/077060). Thus, it is then generally possible—starting from a blue-emitting base polymer (“backbone”)—to generate the two other primary colours red and green.

The conjugated polymers in accordance with the prior art in some cases already exhibit good properties on use in PLEDs. In spite of the advances achieved in recent years, however, these do not yet meet the requirements made of them for high-quality applications. Thus, the photostability of the polymers in accordance with the prior art is still in no way satisfactory, i.e. the polymers in some cases decompose under the influence of light. This is particularly true on irradiation with blue and UV light. As a consequence, the efficiency of the light emission by the polymers drops drastically. It would thus be desirable to have available here polymers which do not exhibit these problems, but whose further properties in the device are just as good or better than the device properties of the polymers in accordance with the prior art.

Surprisingly, it has now been found that conjugated polymers comprising coumarin units or sulfur or selenium homologues thereof or quinolinone units as blue- or green-emitting unit have very good properties which are superior to the prior art. This relates in particular to the photostability, but also to the efficiency of the polymers. The present invention therefore relates to these polymers and to the use thereof in PLEDs.

The use of coumarins in combination with polymers in organic light-emitting diodes has already been described in the literature. In most cases, however, a coumarin derivative is mixed with a polymer (for example S. A. Swanson et al., Chem. Mater. 2003, 15, 2305). However, these blends have crucial disadvantages: the components in blends are generally not ideally miscible with one another and thus tend to significantly poorer film formation, phase separation in the film and/or crystallization of the coumarin units. The formation of a homogeneous film, as is essential for use in light-emitting diodes, is frequently impossible. Phase separation in the device is also observed on extended operation and results in a reduction in the lifetime and in colour instabilities.

EP 0278754 describes coumarin derivatives which are substituted by at least one hydroxyl group and which can be used for attachment as side group of polymers. These polymers can be used as light-emitting layer in organic light-emitting diodes. However, the polymers described are non-conjugated polymers. No device data on the use of these polymers in PLEDs are given, and it must consequently be assumed that the voltages and lifetimes achieved in this way are unsatisfactory. It must be assumed that, in particular, the voltage is too high since charge transport by non-conjugated polymers is generally significantly reduced. This also applies to further non-conjugated polymers which comprise coumarin units in the side chain and are described in a number of patent applications and publications (for example JP 04359989; EP 0661366; Z. Y. Lu et al., Chin. Chem. Lett. 2002, 13, 674; M. A. Tlenopatchev et aL., Polymer J. 1997, 29, 622), equally to non-conjugated dendrimers (for example A. W. Freeman et al., J. Am. Chem. Soc. 2000, 122, 12385). An external quantum efficiency of only 0.012%, which is significantly inferior to the then prior art and is unusable for a commercial application, is indicated therein for a dendrimer which has bonded coumarin to the centre of the dendrimer via an ester link, on use in an organic light-emitting diode. Non-conjugated polymers which comprise coumarin in the main chain likewise do not exhibit satisfactory properties in electroluminescence. Thus, for example, S. Fomine et al. (Macromol. Chem. Phys. 1997, 198, 3065) describe aromatic polyesters comprising coumarin units in the main chain which, on use in PLEDs, exhibit a use voltage of 6-8 V, which is significantly too high for industrial use. The same authors furthermore describe similar coumarin-containing polyesters (Macromol. Chem. Phys. 1997, 198, 1679), which exhibit an improved use voltage of 4 V. This voltage is nevertheless likewise still too high for industrial use. In addition, no data are given on efficiencies and lifetimes, which suggests that these are unsatisfactory, and the polymers have to be processed from solvents which are dubious from a health point of view (chlorinated hydrocarbons).

Coumarin units which are bonded to poly(phenyleneethynylene) via flexible, non-conjugated groups are described by A. R. A. Palmans et al. (Macromolecules 1999, 32, 4677). The coumarin units are used as photochemical sensitizers here, which transfer their energy to the polymer after irradiation. The fluorescence then arises from the polymer backbone. The use of these polymers as electroluminescent materials is not presented. However, it cannot be assumed that polymers of this type are suitable for the production of luminescence from the coumarin units since the energy of the polymer is lower than that of the coumarin, and consequently emission cannot take place from the coumarin unit.

The invention relates to conjugated polymers, oligomers and dendrimers comprising at least 1 mol %, preferably at least 5 mol %, particularly preferably at least 10 mol %, of units of the formula (1) 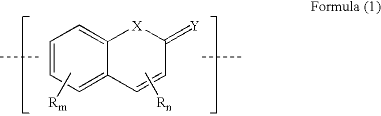
where the symbols and indices used have the following meaning:
X is on each occurrence, identically or differently, oxygen, sulfur, selenium or an N(R1) group;
Y is on each occurrence, identically or differently, oxygen, sulfur or selenium;
R is on each occurrence, identically or differently, a straight-chain, branched or cyclic alkyl or alkoxy chain having 1 to 22 C atoms, in which, in addition, one or more non-adjacent C atoms may be replaced by —C(R1)═C(R1)—, —C≡C—, —N(R1)—, —O—, —S—, —CO—O— or —O—CO—O— and in which one or more H atoms may be replaced by fluorine, an aryl, heteroaryl or aryloxy group having 5 to 40 C atoms, in which, in addition, one or more C atoms may be replaced by O, S or N and which may also be substituted by one or more non-aromatic radicals R and in which two or more of the radicals R may form an aliphatic or aromatic, mono- or polycyclic ring system with one another, or fluorine, chlorine, hydroxyl, CN, N(R1)₂, Si(R1)₃ or B(R1)₂;
R1 is on each occurrence, identically or differently, H, a straight-chain, branched or cyclic alkyl chain having 1 to 22 C atoms, in which, in addition, one or more non-adjacent C atoms may be replaced by —O—, —S—, —CO—O— or —O—CO—O— and in which one or more H atoms may be replaced by fluorine, an aryl or heteroaryl group having 5 to 40 C atoms, in which, in addition, one or more C atoms may be replaced by O, S or N and which may also be substituted by one or more non-aromatic radicals R¹; a plurality of radicals R¹ or R¹ here may also form an aromatic or aliphatic, mono- or polycyclic ring system with further radicals R;
m is on each occurrence, identically or differently, 0, 1, 2, 3 or 4, with the proviso that
   m cannot be 4 if a link to the polymer runs directly via the carbocyclic system, and with the further proviso that m cannot be 3 or 4 if both links to the polymer run directly via the carbocyclic system;
n is on each occurrence, identically or differently, 0, 1 or 2, with the proviso that n cannot be 2 if a link to the polymer runs directly via the heterocyclic system, and with the further proviso that n=0 if both links to the polymer run directly via the heterocyclic system;
   with the exception of conjugated poly(phenyleneethynylenes).

The dashed bond in formula (1) and in all other formulae denotes the link in the polymer, oligomer or dendrimer; it is not intended to represent a methyl group here. The linking of the formula (1) can take place along the polymer main chain or alternatively in the polymer side chain.

For the purposes of this invention, conjugated polymers are polymers which contain principally sp²-hybridised (or optionally also sp-hybridised) carbon atoms, which may also be replaced by corresponding hetero atoms, in the main chain. In the simplest case, this means the alternating presence of double and single bonds in the main chain, but polymers comprising units such as, for example, meta-linked phenylene should also be regarded as conjugated polymers for the purposes of this invention. Principally it means that naturally (spontaneously) occurring defects which result in interruptions to the conjugation do not invalidate the term “conjugated polymer”. Furthermore, the term conjugated is likewise used in this application text if, for example, arylamine units, arylphosphine units and/or certain heterocycles (i.e. conjugation via N, O, P or S atoms) and/or organometallic complexes (i.e. conjugation via the metal atom) are located in the main chain. An analogous situation applies to conjugated dendrimers and oligomers.

The term dendrimer here is intended to be taken to mean a highly branched compound which is built up from a multifunctional centre (core) to which branched monomers are bonded in a regular arrangement, so that a tree-like structure is obtained. Both the centre and the monomers can adopt any desired branched structures here which consist both of purely organic units and also organometallic compounds or coordination compounds. Dendrimer here is intended to be understood generally as described, for example, by M. Fischer and F. Vögtle (Angew. Chem., Int. Ed. 1999, 38, 885).

The units of the formula (1) may, in accordance with the invention, be incorporated into the main chain and/or side chain of the polymer. In the case of incorporation into the side chain, the possibility exists that the unit of the formula (1) is in conjugation with the polymer main chain or that it is non-conjugated with the polymer main chain.

In a preferred embodiment of the invention, the unit of the formula (1) is in conjugation with the polymer main chain. This can be achieved on the one hand by incorporating this unit into the main chain of the polymer in such a way that the conjugation of the polymer is thereby retained, as described above. On the other hand, this unit can also be linked into the side chain of the polymer in such a way that conjugation exists with the main chain of the polymer. This is the case, for example, if the linking to the main chain takes place only via sp²-hybridised (or optionally also via sp-hybridised) carbon atoms, which may also be replaced by corresponding hetero atoms. However, if the linking takes place through units such as, for example, simple (thio)ether bridges, esters, amides or alkylene chains, the structural unit of the formula (1) is defined as non-conjugated with the main chain.

For better understanding of the following description, the numbering of the coumarin unit (=2H-benzo-1-pyran-2-one) is indicated here; the numbering of the sulfur, selenium and nitrogen derivatives takes place correspondingly:

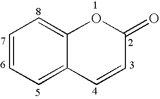

The units of the formula (1) can be incorporated into the main chain of the conjugated polymer via any two of positions 3, 4, 5, 6, 7 or 8.

It is preferred here for the linking to take place in such a way that an even number of C atoms lies between the linking points, i.e. the linking takes place via positions 3 and 4, 3 and 5, 3 and 7, 4 and 6, 4 and 8, 5 and 6, 5 and 8, 6 and 7 or 7 and 8.

It is particularly preferred for the linking to take place via the benzo unit, in particular via positions 5 and 8.

The linking of the units of the formula (1) into the side chain of the conjugated polymer can take place via any one of positions 3, 4, 5, 6, 7 or 8.

It is preferred here for the linking to take place via the benzo unit, i.e. via position 5, 6, 7 or 8. Particular preference is given to linking via position 7.

The linking to the main chain can take place here via various units. Preference is given to linking in conjugation with the main chain. Preferred units for the linking are aromatic units, di- and triarylamino units, arylenevinylene or aryleneethynylene units.

Besides units of the formula (1), the polymers according to the invention preferably also comprise further structural elements and should thus be referred to as copolymers. Reference may also be made here, in particular, to the relatively extensive listing in WO 02/077060, in the unpublished application specification DE 10337346.2 and the references cited therein. These further structural units may originate, for example, from the classes described below:

Group 1: Comonomers which Form the Polymer Backbone:

Units in this group are units which comprise aromatic, carbocyclic structures having 6 to 40 C atoms. Fluorene derivatives (for example EP 0842208, WO 99/54385, WO 00/22027, WO 00/22026, WO 00/46321) come into consideration here. Spirobifluorene derivatives (for example EP 0707020, EP 0894107, WO 03/020790) are furthermore also a possibility. Polymers which comprise a combination of the two first-mentioned monomer units, as disclosed in WO 02/077060, have also already been proposed. The unpublished application DE 10337346.2 describes dihydrophenanthrene derivatives. WO 04/041901 and EP 0301402.0 describe indenofluorene derivatives. However, other structural elements which are able to influence the morphology, but also the emission colour of the resultant polymers are also possible. Preference is given here to substituted or unsubstituted aromatic structures which have 6 to 40 C atoms or stilbene or bisstyrylarylene derivatives, such as, for example, 1,4-phenylene, 1,4-naphthylene, 1,4- or 9,10-anthrylene, 1,6- or 2,7- or 4,9-pyrenylene, tetrahydropyrenylene, 3,9- or 3,10-perylenylene, 2,7- or 3,6-phenanthrenylene, 4,4′-biphenylylene, 4,4″-terphenylylene, 4,4′-bi-1,1′-naphthylylene, 4,4′-stilbenyl- or 4,4″-bisstyrylarylene derivatives.

Preferred units for the polymer backbone are spirobifluorenes, fluorenes, indenofluorenes and dihydrophenanthrenes.

Group 2: Comonomers which Increase the Hole-Injection and/or -Transport properties of the polymers:

These are generally aromatic amines or electron-rich heterocyclic compounds, such as, for example, substituted or unsubstituted triarylamines, benzidines, tetraarylene-para-phenylenediamines, phenothiazines, phenoxazines, dihydrophenazines, thianthrenes, dibenzo-p-dioxins, phenoxathiynes, carbazoles, azulenes, thiophenes, pyrroles, furans and further O—, S— or N-containing heterocyclic compounds having a high HOMO (HOMO=highest occupied molecular orbital). However, triarylphosphines, as described in the unpublished application EP 03018832.0, are also suitable here.

Group 3: Comonomers which Significantly Increase the Electron-Injection and/or -Transport Properties of the Polymers:

These are generally electron-poor aromatic or heterocyclic compounds, such as, for example, substituted or unsubstituted pyridines, pyrimidines, pyridazines, pyrazines, oxadiazoles, quinolines, quinoxalines or phenazines, but also compounds such as triarylboranes and further O—, S— or N-containing heterocyclic compounds having a low LUMO (LUMO=lowest unoccupied molecular orbital).

It is also permissible here for more than one structural unit from one of groups 1-3 to be present at the same time.

The polymer may furthermore likewise comprise metal complexes, which are generally built up from one or more ligands and one or more metal centres, bonded into the main or side chain.

Preference is given to polymers according to the invention which, besides structural units of the formula (1), additionally comprise one or more units selected from groups 1 to 3 at the same time.

Preference is given here to polymers according to the invention which, besides units of the formula (1), also comprise units from group 1, particularly preferably at least 50 mol % of these units.

It is likewise preferred for the polymers according to the invention to comprise units which improve the charge transport or charge injection, i.e. units from group 2 and/or 3; particular preference is given to a proportion of 2-30 mol % of these units; very particular preference is given to a proportion of 10-20 mol % of these units.

It is furthermore particularly preferred for the polymers according to the invention to comprise units from group 1 and units from group 2 and/or 3, in particular at least 50 mol % of units from group 1 and 2-30 mol % of units from group 2 and/or 3.

Preference is furthermore given to a proportion of 5-45 mol % of units of the formula (1). Particular preference is given to a proportion of 10-30 mol % of units of the formula (1).

The polymers according to the invention generally have 10 to 10,000, preferably 20 to 5000, particularly preferably 50 to 2000, recurring units. Corresponding dendrimers and oligomers may also have fewer recurring units.

The requisite solubility of the polymers is ensured in particular by the substituents on the various recurring units, both the substituents R and R¹ on units of the formula (1), and also by substituents on the other recurring units.

Preference is furthermore given to polymers according to the invention in which the following applies to units of the formula (1):
X is on each occurrence, identically or differently, oxygen, sulfur or an N(R1) group;
Y is on each occurrence, identically or differently, oxygen or sulfur;
m is on each occurrence, identically or differently, 0, 1, 2 or 3, with the proviso that m cannot be 3 if both links to the polymer run directly via the carbocyclic system;
   the other symbols and indices are as defined above under formula (1).

Particular preference is furthermore given to polymers according to the invention in which the following applies to units of the formula (1):
X is on each occurrence, identically or differently, oxygen or an N(R1) group;
Y is on each occurrence oxygen;
m is on each occurrence, identically or differently, 0, 1 or 2;
n is on each occurrence, identically or differently, 0 or 1;
   the other symbols are as defined above under formula (1).

Very particular preference is given to polymers according to the invention in which the following applies to units of the formula (1):
X is on each occurrence oxygen;
Y is on each occurrence oxygen;
m is on each occurrence, identically or differently, 0 or 1;
n is on each occurrence, identically or differently, 0 or 1;
   the other symbols are as defined above under formula (1).

Examples of preferred structures of the formula (1) for incorporation into the polymer main chain are structures of the formulae (2) to (16), those for incorporation into the polymer side chain are structures of the formulae (17) to (26), where the linking in the polymer is in each case indicated by the dashed bonds, and the structures may in each case be substituted by R or unsubstituted. It is also possible for the structures of the formula (1) to be dimeric (or even oligomeric) structures, which thus comprise two or more such units bonded to one another. Examples of such structures are structures of the formulae (27) and (28).

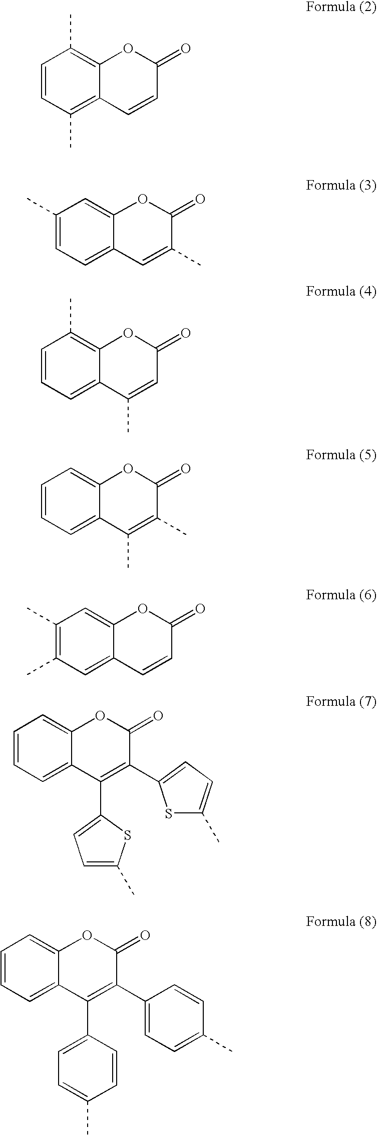

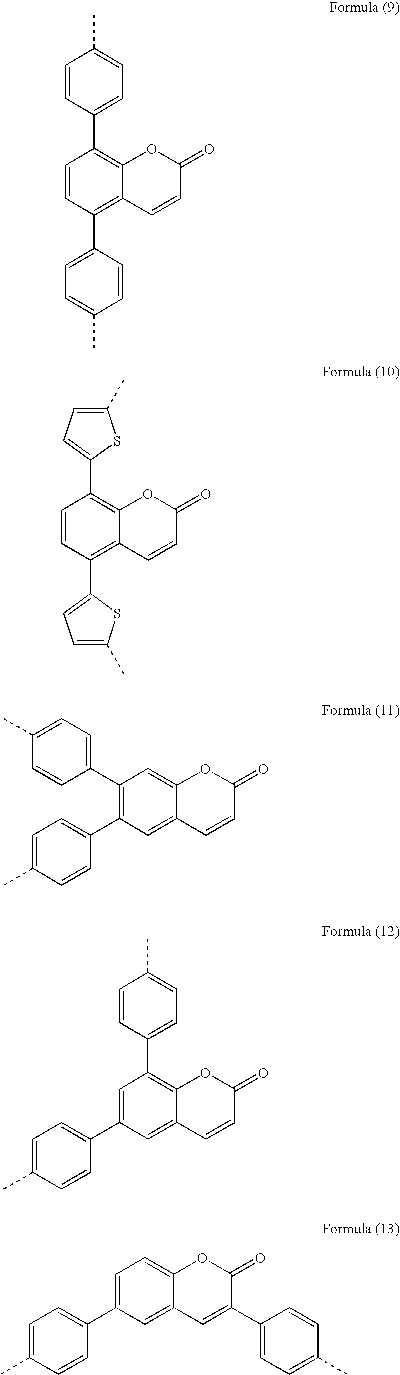

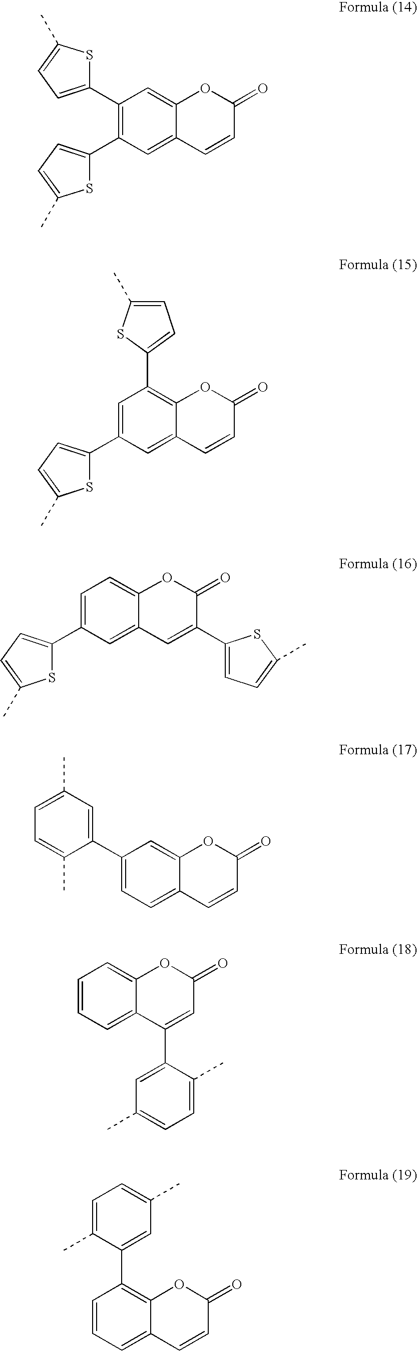

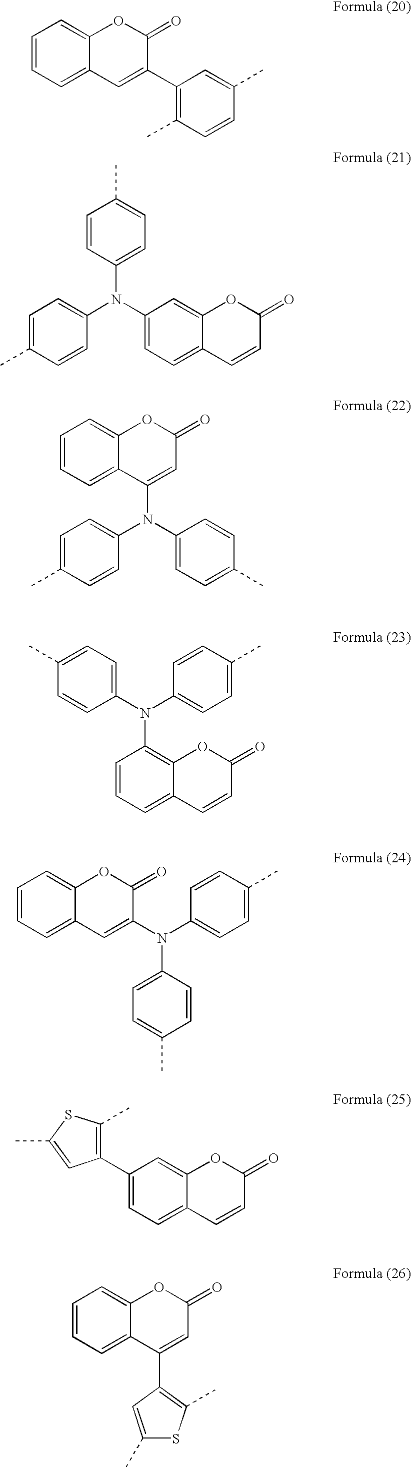

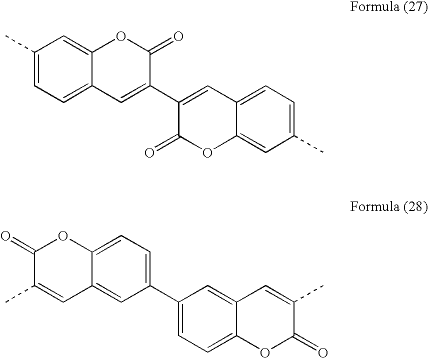

The polymers according to the invention are either homopolymers comprising units of the formula (1) or copolymers. Besides one or more structures of the formula (1), or of the formulae (2) to (28), copolymers according to the invention may potentially have one or more further structures from groups 1 to 3 mentioned above.

The copolymers according to the invention may have random, alternating or block-like structures or also have a plurality of these structures in an alternating arrangement. The way in which copolymers having block-like structures can be obtained and what other structural elements are particularly suitable for this purpose is described, for example, in the unpublished application DE 10337077.3. It should likewise again be emphasised at this point that the polymer may also have dendritic structures.

It may also be preferred for a significantly smaller proportion than 1 mol % of structural units of the formula (1) to be used. Thus, 0.01 to 1 mol % of such units can be used, for example, as green-emitting units for the synthesis of white-emitting copolymers. A very small proportion of green-emitting units is generally necessary for this purpose, as described in the unpublished application DE 10343606.5. The invention thus also relates to the use of structural units of the formula (1) for the synthesis of white-emitting copolymers. Structural units of the formula (1) can likewise be used as green- (or also blue-)emitting comonomers for the synthesis of red-emitting polymers. The invention thus furthermore relates to the use of structural units of the formula (1) for the synthesis of red-emitting polymers.

The polymers according to the invention are generally prepared by polymerisation of one or more types of monomer, of which at least one monomer is described by the formula (1). There are in principle many corresponding polymerisation reactions. However, some types, all of which result in C-C links, have proven particularly successful here:
(A) SUZUKI polymerisation;
(B) YAMAMOTO polymerisation;
(C) STILLE polymerisation.

The way in which the polymerisation can be carried out by these methods and the way in which the polymers can then be separated off from the reaction medium and purified is described, for example, in detail in WO 04/037887.

For the synthesis of the polymers, the corresponding monomers are required.

For the synthesis of units from groups 1 to 3, reference may only be made at this point to DE 10337346.2 and the literature cited therein.

Monomers which result in structural units of the formula (1) in polymers according to the invention are coumarins and corresponding sulfur, selenium and nitrogen derivatives which are suitably substituted at suitable positions and have suitable functionalities which allow this monomer unit to be incorporated into the polymer.

The literature describes the synthesis of various mono- and dibromocoumarins and derivatives thereof which can be employed directly as monomers for the polymerisation or can be further functionalised by subsequent reactions (for example Heterocycles 2003, 59, 217; Indian J. Chem., Sec. B 1999, 38B, 1242; Bioorganicheskaya Khimiya 1988, 14, 236; Ind. J. Chem., Sec. B 1982, 21B, 767; Chem. Phar. Bull. 1996, 44, 1986; Phosphorus, Sulfur and Silicon 2003, 178, 501; Ind. J. Chem., Sec. B 2000, 39B, 62; Can. J. Chem. 1982, 60, 1092; Chem. Phar. Bull. 1994, 42, 2170; Tetrahedron Lett. 2001, 42, 4849; Synlett 2002, 2059). Corresponding thio- and selenocoumarins (for example A. Ruwet, M. Renson, Bull. Soc. Chim. Belg. 1968, 77, 465), which may likewise be functionalised, are also known. The nitrogen derivatives can be synthesised correspondingly.

The coumarin skeleton can be constructed by the Perkin reaction (W. H. Perkin, Liebigs Ann. Chem. 1868, 147, 229; J. Chem. Soc. 1868, 21, 53) or modifications of this synthesis in the broadest sense. For this purpose, an (optionally substituted) salicylaldehyde is reacted with acetic anhydride in the presence of sodium acetate (for example as described by J. Kumanotani etal., J. Soc. Org. Synthet. Chem. 1953, 11, 388). In variations, for example, salicylaldehyde is reacted under acidic conditions with compounds containing an activated methylene group, for example nitrites (for example in accordance with WO 03/050106). A further possibility is the reaction of phenols with β-keto esters under acidic conditions (for example in accordance with HU 46315). A complete list of all potential syntheses would exceed the scope of this application. The person skilled in the art of organic synthesis will be able to build up a wide variety of non-halogenated, monohalogenated, dihalogenated and oligohalogenated coumarins from the synthetic routes listed by slight variations.

In general, a distinction is made between two synthesis strategies: in the first, the fully constructed coumarin skeleton is brominated. In the other, the starting materials already contain the bromine functionality during construction of the coumarin skeleton. Depending on the target compound, the one or other synthetic route may be preferred.

There are in principle many suitable brominating agents for the synthesis of brominated coumarin derivatives. Thus, for example, brominating agents as mentioned in WO 02/068435 are suitable. Thus, for example, a bromine derivative can be produced by bromination of suitably substituted coumarins, which can either be employed directly as monomer in the polymerisation or converted, by methods familiar to the person skilled in the art, into, for example, boronic acid derivatives or stannanes, which can then likewise be employed in the polymerisation.

However, difficulties become apparent in the bromination in that the proton in the α-position of the unsaturated carbonyl compound (position 3 of the coumarin) can likewise be substituted by bromine, in particular if an electron-donating substituent, such as, for example, a hydroxyl, alkoxy or amino group, is present in position 7 of the coumarin. This bromine substituent in position 3 must thus be selectively debrominated again after the bromination, for example by reaction with a reducing agent.

Debromination using N,N-dimethylaniline is described in the literature (S. R. Ghantwal et al., Ind. J. Chem. 1999, 38B, 1242). In general, reducing agents whose redox potential (against the standard hydrogen electrode) is in a range from −1.5 V to 0.2 V are suitable for this purpose. Preference is given here to metals whose redox potential is in this range, such as, for example, iron, manganese, nickel, zinc or tin. Zinc is particularly preferred.

Monomers which result in units of the formula (20) in the polymer are novel and are therefore likewise a subject-matter of the present invention.

The invention furthermore relates to bifunctional monomeric compounds of the formula (29) 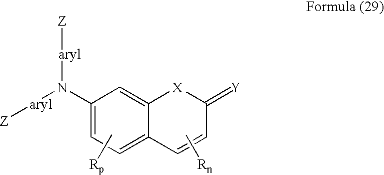
where Y, R, R1 and n have the same meaning as described under formula (1), and the other symbols and indices have the following meaning:
X is on each occurrence, identically or differently, oxygen, sulfur or selenium;
aryl is on each occurrence, identically or differently, an aromatic or heteroaromatic ring system having 2 to 40 C atoms, which may be substituted by R1 or unsubstituted, or a stilbenyl, bisstilbenyl or tolanyl unit which is substituted by R1 or unsubstituted; the possible substituents R1 here may potentially be in any free position; a plurality of substituents R1 here may form an aliphatic or aromatic, mono- or polycyclic ring system with one another or with further substituents R;
Z is on each occurrence, identically or differently, a functional group which copolymerises under conditions of C-C linking, preferably Cl, Br, l, O-tosylate, O-triflate, O—SO₂R1, B(OR1)₂ or Sn(R1)₃;
p is on each occurrence, identically or differently, 0, 1, 2 or 3, preferably 0 or 1, particularly preferably 0.

The C-C links here are preferably selected from the groups of the SUZUKI coupling, the YAMAMOTO coupling and the STILLE coupling.

The polymers according to the invention have the following advantages over the polyspiro-bifluorenes described in WO 03/020790, the polyfluorenes described in WO 02/077060 and the polydihydrophenanthrenes described in DE 10337346.2, which comprise no units of the formula (1) and are cited here as closest prior art:
(1) The polymers according to the invention exhibit higher photostability than polymers in accordance with the prior art. This is of crucial importance for the application of these polymers since they must not be decomposed either by the radiation liberated by electro-lumenescence or by radiation incident from the outside. This property is still un-satisfactory in polymers in accordance with the prior art.
(2) The polymers according to the invention have (with an otherwise identical or similar composition) comparable or higher luminous efficiencies in the application. This is of enormous importance since either the same brightness can thus be achieved with lower energy consumption, which is very important, in particular, in the case of mobile applications (displays for cellphones, pagers, PDAs, etc.) which are reliant on rechargeable batteries. Conversely, higher brightnesses are achieved for the same energy consumption, which may be interesting, for example, for illumination applications.
(3) Furthermore, it has been found, surprisingly, that the polymers according to the invention have comparable or longer operating lifetimes, again in direct comparison.

It may additionally be preferred to use the polymer according to the invention not as the pure substance, but instead as a blend together with any desired further polymeric, oligomeric, dendritic or low-molecular-weight substances. These may improve, for example, the electronic properties or emit themselves. The present invention therefore also relates to blends of this type.

The invention furthermore relates to solutions and formulations comprising one or more polymers or blends according to the invention in one or more solvents. The way in which polymer solutions can be prepared is described, for example, in WO 02/072714, WO 03/019694 and the literature cited therein.

These solutions can be used in order to produce thin polymer layers, for example by surface-coating methods (for example spin coating) or by printing methods (for example ink-jet printing).

The polymers according to the invention can be used in PLEDs. The way in which PLEDs can be produced is described in detail as a general process in WO 04/037887, which should be adapted correspondingly to the individual case.

As described above, the polymers according to the invention are very particularly suitable as electroluminescent materials in PLEDs or displays produced in this way.

For the purposes of the invention, electroluminescent materials are taken to mean materials which can be used as active layer in a PLED. Active layer means that the layer is capable of emitting light on application of an electric field (light-emitting layer) and/or that it improves the injection and/or transport of the positive and/or negative charges (charge-injection or charge-transport layer).

The invention therefore also relates to the use of a polymer or blend according to the invention in a PLED, in particular as electroluminescent material.

The invention thus likewise relates to a PLED comprising one or more active layers, where at least one of these active layers comprises one or more polymers according to the invention. The active layer may be, for example, a light-emitting layer and/or a transport layer and/or a charge-injection layer.

In the present application text and also in the examples below, the aim is the use of polymers or blends according to the invention in relation to PLEDs and corresponding displays. In spite of this restriction of the description, it is readily possible for the person skilled in the art, without inventive step, to use the polymers according to the invention as semiconductors also for further uses in other electronic devices, for example in organic field-effect transistors (O-FETs), in organic integrated circuits (O-ICs), in organic thin-film transistors (O-TFTs), in organic solar cells (O-SCs) or also in organic laser diodes (O-lasers), to mention but a few applications.

The present invention likewise relates to the use of the polymers according to the invention in the corresponding devices.

It is likewise an easy task for the person skilled in the art to transfer the above descriptions for conjugated polymers to conjugated dendrimers or oligomers without a further inventive step. The present invention thus also relates to conjugated dendrimers and oligomers of this type.

### EXAMPLES

### Example 1

### Synthesis of the Diarylamine-Substituted Coumarin Monomer CUM1 According to the Invention

### a) 2-(3-Bromophenoxy)tetrahydropyran

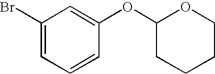

A solution of 74.66 g (431.6 mmol) of 3-bromophenol in 1500 ml of dichloromethane was added dropwise with rapid stirring to 43.4 ml (474.8 mmol) of 3,4-dihydropyran and 15 drops of concentrated hydrochloric acid. The mixture was stirred overnight at room temperature, and 300 ml of 1N NaOH were subsequently added. The organic phase was separated off and dried over MgSO₄, and the solvent was removed under reduced pressure. The pure product was obtained by recrystallisation from hexane. The yield, with a purity of 96% according to HPLC, was 104 g (94% of theory).

¹H-NMR (CDCl₃, 500 MHz): 1.52-2.15 (m, 6H), 3.56 (m, 1H), 3.88 (m, 1H), 5.41 (t, J=3.3 Hz, 1H), 6.98 (dd, ²J=7.3 Hz, ³J=1.6 Hz, 1H), 7.11 (d, J=1.6 Hz, 1H), 7.13 (d, J=7.3 Hz, 1H), 7.23 (d, J=1.6 Hz, 1H).

### b) N,N-diphenyl-[N-3-(tetrahydropyran-2-yloxy)phenyl]amine

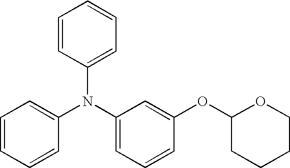

A degassed solution of 56.2 g (332 mmol) of diphenylamine and 100 g (365 mmol) of 2-(3-bromophenoxy)tetrahydropyran in 1000 ml of toluene was saturated with N₂ for 1 h. Then, firstly 1.35 g (6.67 mmol) of P(tBu)₃, then 0.748 g (3.3 mmol) of Pd(OAc)₂ were added to the solution, and 3.8 g (50.4 mmol) of NaOtBu as a solid were subsequently added. The reaction mixture was heated under reflux for 5 h. After cooling to room temperature, 5 g of NaCN and 300 ml of water were carefully added. The organic phase was washed with 4×100 ml of H₂O and dried over MgSO₄, and the solvents were removed under reduced pressure. The pure product was obtained by recrystallisation from hexane. The yield, with a purity of 91.3% according to HPLC, was 100 g (80% of theory).

¹H-NMR (CDCl₃, 500 MHz): 1.52-2.15 (m, 6H), 3.56 (m, 1H), 3.88 (m, 1H), 5.41 (t, J=0.3 Hz, 1H), 6.68 (m, 1H), 6.71 (m, 1H), 6.76 (d, J=2.3 Hz, 1H), 7.00 (t, J=7.3 Hz, 4H). (d, J=8.3 Hz, 4H), 7.13 (t, J=8.3 Hz, 1H), 7.23 (dd, ²J=8.3 Hz, ³J=7.3 Hz, 4H).

### c) 3-(N,N-diphenylamino)phenol

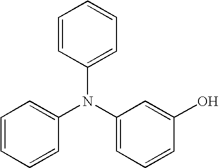

87 g (251 mmol) of diphenyl-[N-3-(tetrahydropyran-2-yloxy)phenyl]amine were initially introduced in 500 ml of MeOH and heated to 50° C. 9.4 g (50 mmol) of p-toluenesulfonic acid were added with stirring, and the mixture was stirred overnight. 100 ml of water were added to the mixture, the organic phase was separated off and dried over MgSO₄, and the solvents were removed under reduced pressure. The pure product was obtained by recrystallisation from hexane/MeOH (3:1). The yield, with a purity of 95.4% according to HPLC, was 59 g (90% of theory).

¹H-NMR (CDCl₃, 500 MHz): 4.9 (s, 1H), 6.43 (m, 1H), 6.50 (t, J=7.3 Hz, 1H), 7.00 (t, J=7.3 Hz, 2H), 7.06 (t, J=8.3 Hz, 1H), 7.34 (d, J=8.3 Hz, 4H), 7.22 (dd, ²J=8.3 Hz, ³J=7.3 Hz, 4H).

### d) 7-(N,N-diphenylamino)-4-methylcoumarin

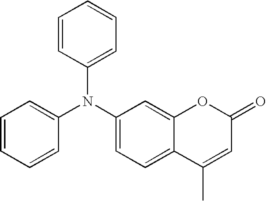

A mixture of 73 g (292 mmol) of 3-(N,N-diphenylamino)phenol, 38 g (292 mmol) of ethyl acetoacetate and 350 ml of nitrobenzene was heated to 100° C. 77.3 g (584 mmol) of anhydrous aluminium trichloride were added in portions, and the mixture was heated at 130° C. for 3 h. The reaction mixture was cooled, and 75 ml of semi-concentrated hydro-chloric acid were added at room temperature. The pure product was obtained by recrystallisation from ethyl acetate. The yield, with a purity of 97% according to HPLC, was 59 g (54%).

¹H-NMR (CDCl₃, 500 MHz): 2.38 (s, 3H), 6.08 (s, 1H), 6.83 (d, J=2.3 Hz, 1H), 6.88 (dd, ²J=8.7 Hz, ³J=2.3 Hz, 1H), 7.15 (t, J=7.3 Hz, 2H), 7.16 (d, J=9.0 Hz, 4H), 7.35 (m, 5H).

### e) 7-[N,N-bis(4-bromophenyl)amino]-3-bromo-4-methylcoumarin

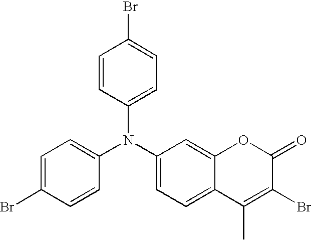

2.4 g (7.47 mmol) of 7-(N,N-diphenylamino)-4-methylcoumarin in 35 ml of CHCl₃ were cooled to 0° C., 3.9 g (22.2 mmol) of NBS were added in portions with exclusion of light, and the mixture was stirred overnight at room temperature. 40 ml of Na₂SO₃ solution were subsequently added to the mixture. The phases were separated, the organic phase was dried over MgSO₄, and the solvents were removed under reduced pressure. The residue was purified by recrystallisation from ethyl acetate. The yield, with a purity of 98% according to HPLC, was 3 g (90% of theory).

¹H-NMR (CDCl₃, 500 MHz): 2.58 (s, 3H), 6.84 (d, J=2.3 Hz, 1H), 6.90 (dd, ²J=9.0 Hz, ³J=2.3 Hz, 1H), 7.01 (d, J=9.0 Hz, 4H), 7.44 (d, J=9.0 Hz, 1H), 7.46 (d, J=9.0 Hz, 4H).

### f) 7-[N,N-bis(4-bromophenyl)amino]-4-methylcoumarin (monomer CUM1)

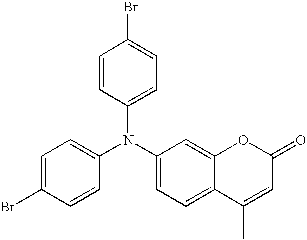

12 g (37.3 mmol) of 7-[N,N-bis(4-bromophenyl)amino]-3-bromo-4-methylcoumarin were added to a mixture of 16 g (250 mmol) of zinc dust and 100 ml of glacial acetic acid. The reaction mixture was stirred at 80° C. for 3 days. The mixture was subsequently washed with 250 ml of water, the residue was filtered off, and the product was recrystallised from acetone/hexane (1:2). The yield, with a purity of 99.8% according to HPLC, was 4.6 g (80% of theory).

¹H-NMR (CDCl₃, 500 MHz): 2.58 (s, 3H), 6.12 (s, 1H), 6.85 (d, J=2.3 Hz, 1H), 6.88 (dd, ²J=9.0 Hz, ³J=2.3 Hz, 1H), 7.01 (d, J=9.0 Hz, 4H), 7.40 (d, J=9.0 Hz, 1H), 7.55 (d, J=9.0 Hz, 4H).

### Example 2

### Synthesis of Further Comonomers

The structures of the further monomers (M) for polymers according to the invention and comparative polymers are shown below. The synthesis of the monomers M is described in WO 03/020790, in DE 10337346.2 and the literature cited therein.

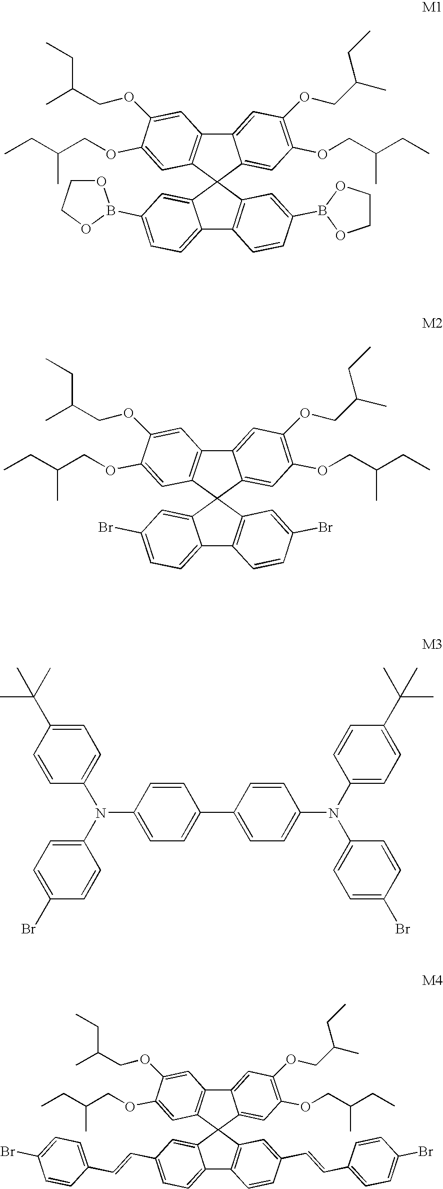

### Example 3

### Synthesis of the Polymers

The polymers were synthesised by SUZUKI coupling in accordance with WO 03/048225 or by YAMAMOTO coupling in accordance with WO 04/022626. The composition of synthesised polymers P1 and P2 is summarised in Examples 4 and 5.

### Example 4

### Polymer P1 and Comparative Polymer V1

Polymer P1 was synthesised as described in Example 3 and comprises 50 mol % of monomer M1, 30 mol % of monomer M2, 10 mol % of monomer M3 and 10 mol % of monomer CUM1. A comparative polymer V1 was likewise synthesised (referred to as standard in Example 7) which comprises 10 mol % of monomer M4 instead of monomer CUM1.

### Example 5

### Polymer P2

Polymer P2 was synthesised as described in Example 3 and comprises 50 mol % of monomer M1, 40 mol % of monomer M2 and 10 mol % of monomer CUM1.

### Example 6

### Production of the PLEDs

The polymers were also investigated for use in PLEDs. The PLEDs were in each case two-layer systems, i.e. substrate//ITO//PEDOT//polymer//cathode. PEDOT is a polythiophene derivative (Baytron P, from H. C. Stark, Goslar). The cathode used in all cases was Ba/Ag (both from Aldrich). The way in which PLEDs can be produced has already been described in detail in WO 04/037887 and the literature cited therein.

### Example 7

### Comparison of the Photostability

The photostability of polymers P1 and P2 was investigated in a fluorescence spectrometer together with the comparative polymer V1 (“standard”) as closest prior art. The samples were prepared in a configuration based on the actual device, namely on ITO, the typical transparent anode material (layer thickness 150 nm), and 80 nm of PEDOT. The thickness of the applied polymer film was 80 nm. An absorption spectrum and a photoluminescence spectrum of each film were firstly measured, then the film was exposed at the absorption maximum in the fluorescence spectrometer for 30 min. at constant gap width (5 nm), while the photoluminescence was detected at the maximum over time. The sample chamber was flushed with nitrogen during the measurement in order to exclude any effects caused by atmospheric oxygen. In order to be able to compare the polymers with one another, the detected photoluminescence was standardised to 1. After this so-called time scan, a photoluminescence spectrum was again measured in order to exclude that the spectra could have shifted during the measurement. In all 3 cases investigated, no relevant shift in the emission maximum was observed.

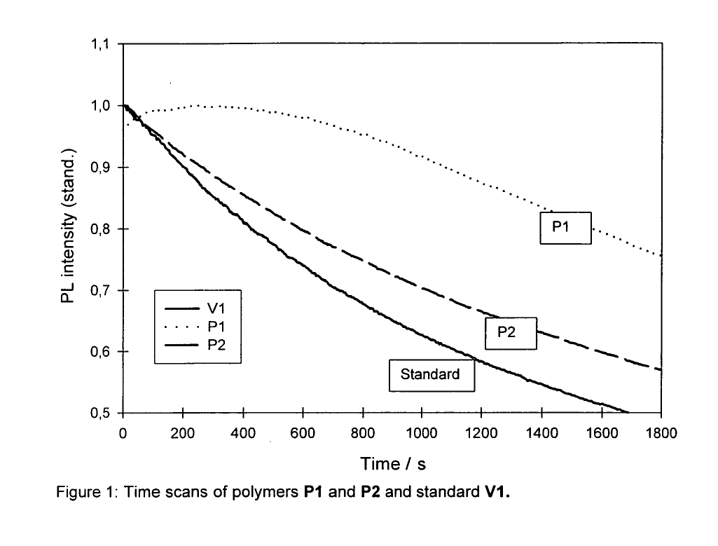

FIG. 1 shows the results of the time scan for polymers P1, P2 and V1 (standard in accordance with the prior art). While the comparative standard only emits half of the original photoluminescence after less than 30 min., polymers P1 and P2 are significantly more stable. Polymer P1 in particular still exhibits 75% of the original luminescence after half an hour, in spite of intensive irradiation. However, P2 is also significantly more stable compared with the prior art. Monomer units in accordance with Example 1 are therefore suitable for significantly increasing the photostability and thus the lifetime of blue conjugated polymers.

1. Conjugated polymers, oligomers and dendrimers comprising at least 1 mol % of units of the formula (1) 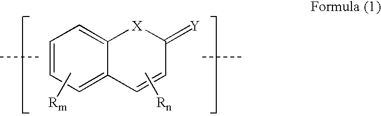
where the symbols and indices have the following meanings:
X is on each occurrence, identically or differently, oxygen, sulfur, selenium or an N(R1) group;
Y is on each occurrence, identically or differently, oxygen, sulfur or selenium;
R is on each occurrence, identically or differently, a straight-chain, branched or cyclic alkyl or alkoxy chain having 1 to 22 C atoms, in which, in addition, one or more non-adjacent C atoms may be replaced by —C(R1)═C(R1)—, —C—≡C—, —N(R1)—, —O—, —S—, —CO—O— or —O—CO—O— and in which one or more H atoms may be replaced by fluorine, an aryl, heteroaryl or aryloxy group having 5 to 40 C atoms, in which, in addition, one or more C atoms may be replaced by O, S or N and which may also be substituted by one or more non-aromatic radicals R and in which two or more of the radicals R may form an aliphatic or aromatic, mono- or polycyclic ring system with one another, or fluorine, chlorine, hydroxyl, CN, N(R1)₂, Si(R1)₃ or B(R1)₂;
R1 is on each occurrence, identically or differently, H, a straight-chain, branched or cyclic alkyl chain having 1 to 22 C atoms, in which, in addition, one or more non-adjacent C atoms may be replaced by —O—, —S—, —CO—O— or —OCO—O— and in which one or more H atoms may be replaced by fluorine, an aryl or heteroaryl group having 5 to 40 C atoms, in which, in addition, one or more C atoms may be replaced by O, S or N and which may also be substituted by one or more non-aromatic radicals R¹; a plurality of radicals R¹ or R¹ here may also form an aromatic or aliphatic, mono- or polycyclic ring system with further radicals R;
m is on each occurrence, identically or differently, 0, 1, 2, 3 or 4, with the proviso that m cannot be 4 if a link to the polymer runs directly via the carbocyclic system, and with the further proviso that m cannot be 3 or 4 if both links to the polymer run directly via the carbocyclic system;
n is on each occurrence, identically or differently, 0, 1 or 2, with the proviso that n cannot be 2 if a link to the polymer runs directly via the heterocyclic system, and with the further proviso that n=0 if both links to the polymer run directly via the heterocyclic system;
with the exception of conjugated poly(phenyleneethynylenes).

2. Polymers according to claim 1, characterised in that the units of the formula (1) are in conjugation with the polymer main chain.

3. Polymers according to claim 1, characterised in that the units of the formula (1) are incorporated into the main chain of the polymer.

4. Polymers according to claim 3, characterised in that the linking takes place in such a way that an even number of C atoms lies between the linking points.

5. Polymers according to claim 1, characterised in that the units of the formula (1) are incorporated into the side chain of the polymer.

6. Polymers according to claim 5, characterised in that the linking takes place via position 5, 6, 7 or 8.

7. Polymers according to claim 5, characterised in that the linking to the main chain takes place via aromatic units, diarylamino units, triarylamino units, arylenevinylene or aryleneethynylene units.

8. Polymers according to claim 1, characterised in that they comprise further structural elements.

9. Polymers according to claim 8, characterised in that the further structural elements are fluorenylenes, spirobifluorenylenes, dihydrophenanthrenylenes, indenofluorenylenes, tetrahydropyrenylenes, stilbenylenes, bisstyrylarylenes, 1,4-phenylenes, 1,4-naphthylenes, 1,4- or 9,10-anthrylenes, 1,6- or 2,7- or 4,9-pyrenylenes, 3,9- or 3,10-perylenylenes, 2,7- or 3,6-phenanthrenylenes, 4,4′-biphenylylenes, 4,4″-terphenylylenes or 4,4′-bi-1,1′-naphthylylenes.

10. Polymers according to claim 8, characterised in that further structural elements are triarylamines, triarylphosphines, benzidines, tetraarylene-para-phenylenediamines, phenothiazines, phenoxazines, dihydrophenazines, thianthrenes, dibenzo-p-dioxins, phenoxathiynes, carbazoles, azulenes, thiophenes, pyrroles or furans.

11. Polymers according to claim 8, characterised in that further structural elements are pyridines, pyrimidines, pyridazines, pyrazines, triarylboranes, oxadiazoles, quinolines, quinoxalines or phenazines.

12. Polymers according to claim 9, characterised in that they comprise at least 50 mol % of units according to claim 9 and 2-30 mol % of structural units and said structural units are triarylamines, triarylphosphines, benzidines, tetraarylene-para-phenylenediamines, phenothiazines, phenoxazines, dihydrophenazines, thianthrenes, dibenzo-p-dioxins, phenoxathiynes, carbazoles, azulenes, thiophenes, pyrroles, furans, pyridines, pyrimidines, pyridazines, pyrazines, triarylboranes, oxadiazoles, quinolines, quinoxalines or phenazines.

13. Polymers according to claim 1, characterised in that the proportion of structural units of the formula (1) is 10 to 30 mol %.

14. Polymers according to claim 1, characterised in that the
X is on each occurrence, identically or differently, oxygen, sulfur or an N(R1) group;
Y is on each occurrence, identically or differently, oxygen or sulfur;
m is on each occurrence, identically or differently, 0, 1, 2 or 3, with the proviso that m cannot be 3 if both links to the polymer run directly via the carbocyclic system; the other symbols and indices are as defined.

15. Polymers according to claim 14, characterised in that the
X is on each occurrence, identically or differently, oxygen or an N(R1) group;
Y is on each occurrence oxygen;
m is on each occurrence, identically or differently, 0, 1 or 2; and
n is on each occurrence, identically or differently, 0 or 1.

16. (canceled)

17. White-emitting conjugated polymers, characterised in that they comprise a proportion of 0.01 to 1 mol % of structural units of the formula (1) as claimed in claim 1.

18. Red-emitting conjugated polymers, characterised in that they comprise at least 1 mol % of structural units of the formula (1) as claimed in claim 1.

19. Blend of one or more polymers according to claim 1 with a further polymeric, oligomeric, dendritic or low-molecular-weight substances.

20. Bifunctional monomeric compounds of the formula (29) 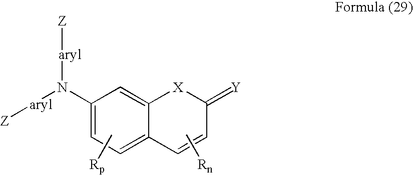
where Y, R, R1 and n have the same meaning as described in claim 1, and the other symbols and indices have the following meaning:
X is on each occurrence, identically or differently, oxygen, sulfur or selenium;
aryl is on each occurrence, identically or differently, an aromatic or heteroaromatic ring system having 2 to 40 C atoms, which may be substituted by R1 or unsubstituted, or a stilbenyl, bisstilbenyl or tolanyl unit which is substituted by R1 or unsubstituted; the possible substituents R1 here may potentially be in any free position; a plurality of substituents R1 here may form an aliphatic or aromatic, mono- or polycyclic ring system with one another or with further substituents R;
Z is on each occurrence, identically or differently, a functional group which copolymerises under conditions of C-C linking;
p is on each occurrence, identically or differently, 0, 1, 2 or 3.

21. Monomers according to claim 20, characterised in that Z stands for Cl, Br, I, O-tosylate, O-triflate, O—SO₂R1, B(OH)₂, B(OR1)₂ or Sn(R1)₃, where R1 is on each occurrence, identically or differently, H, a straight-chain, branched or cyclic alkyl chain having 1 to 22 C atoms, in which, in addition, one or more non-adjacent C atoms may be replaced by —O—, —S—, —CO—O— or —O—CO—O— and in which one or more H atoms may be replaced by fluorine, an aryl or heteroaryl group having 5 to 40 C atoms, in which, in addition, one or more C atoms may be replaced by O, S or N and which may also be substituted by one or more non-aromatic radicals R¹; a plurality of radicals R¹ or R¹ here may also form an aromatic or aliphatic, mono- or polycyclic ring system with further radicals R.

22. Monomers according to claim 20, characterised in that the C-C links are selected from the groups of the SUZUKI coupling, the YAMAMOTO coupling and the STILLE coupling.

23. Solutions and formulations comprising one or more polymers or blends according to claim 1 in one or more solvents.

24. (canceled)

25. Electronic component comprising one or more polymers according to claim 1.

26. Electronic component according to claim 25, characterised in that it is a field-effect transistor (O-FET), an organic thin-film transistor (O-TFT), an organic integrated circuit (O-IC), an organic solar cell (O-SC), an organic light-emitting diode (OLED) or an organic laser diode (O-laser).

27. The electronic component according to claim 26 wherein the component is an organic light-emitting diode.

28. Polymers according to claim 1, characterised in that the structures of the formula (1) are selected from the structures of the formulae (2) to (28), 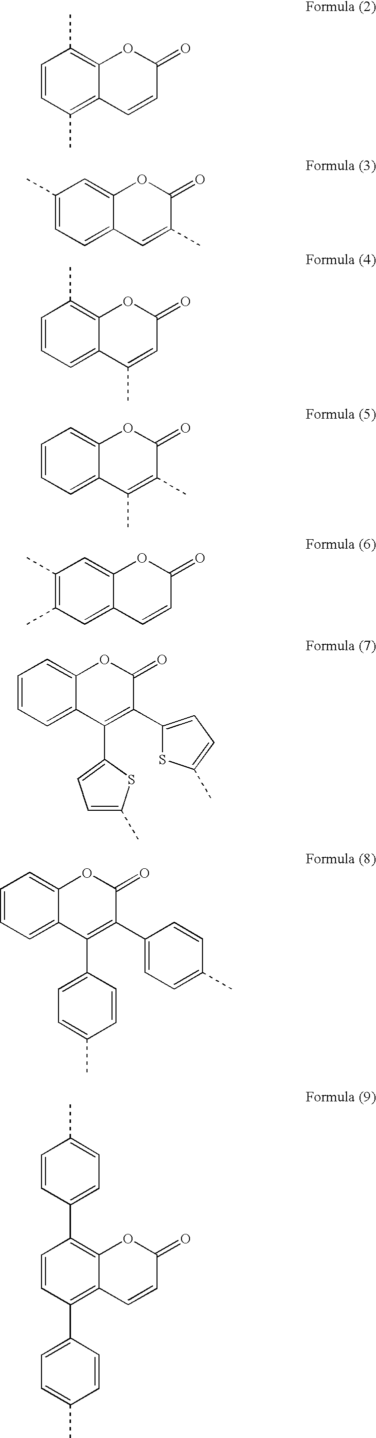 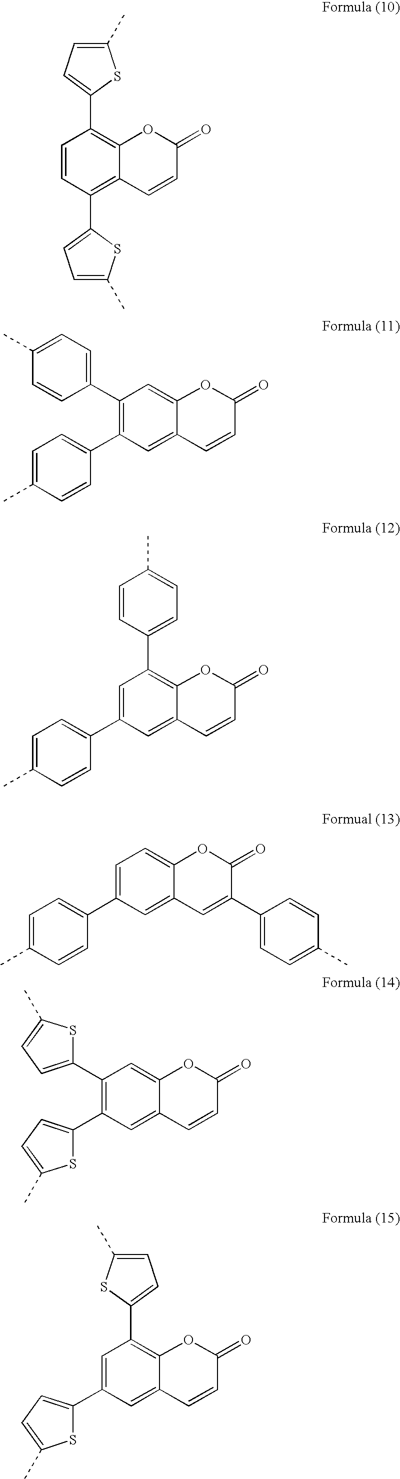 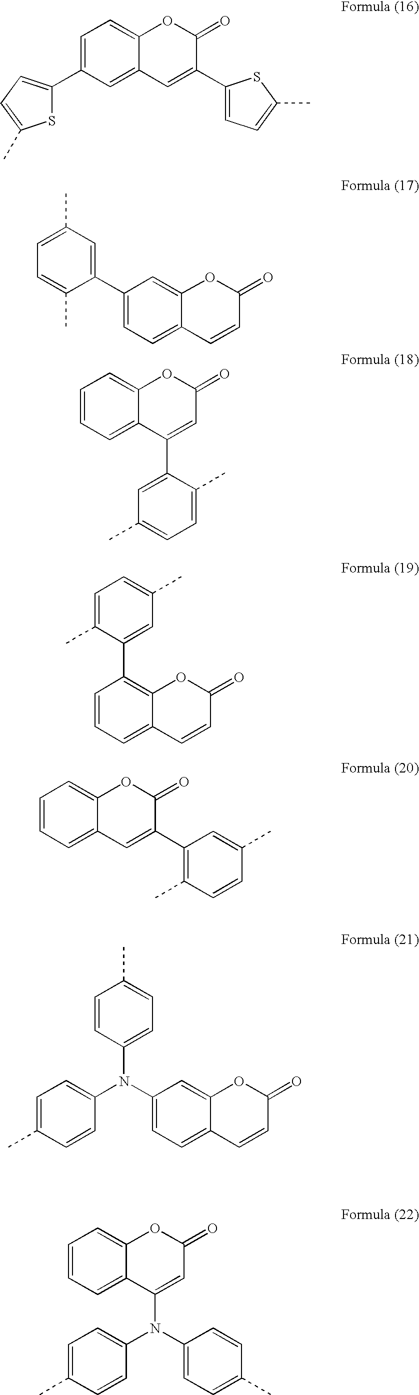 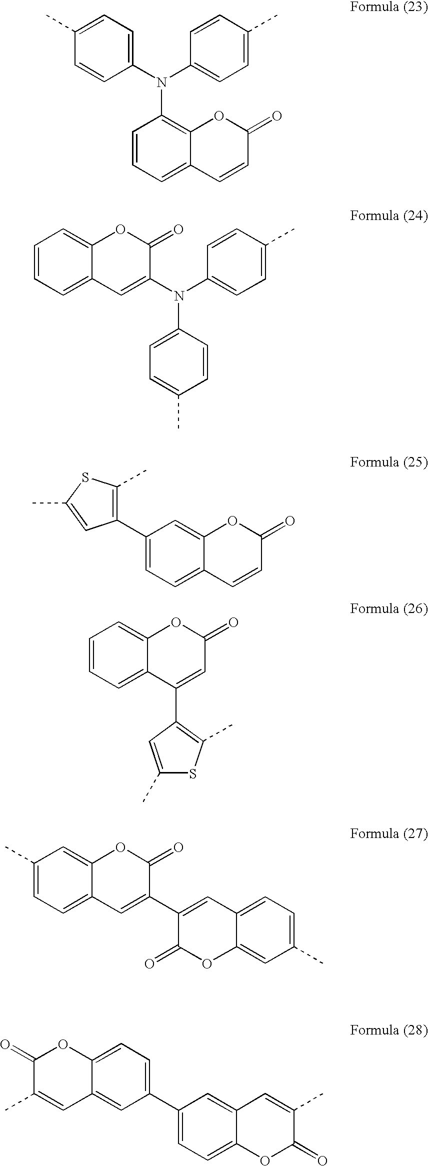
each of which is substituted by R or unsubstituted.
